(19) United States
(12) Patent Application Publication
(10) Pub. No.: US 2009/0058750 A1
(43) Pub. Date: Mar. 5, 2009

(54) HIGH-FREQUENCY MAGNETIC MATERIAL AND ANTENNA DEVICE USING THEREOF

(75) Inventors: Tomoko EGUCHI, Tokyo (JP); Maki Yonetsu, Tokyo (JP); Naoyuki Nakagawa, Kanagawa (JP); Seiichi Suenaga, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/174,016

(22) Filed: Jul. 16, 2008

(30) Foreign Application Priority Data
Aug. 31, 2007 (JP) 2007-226401

(51) Int. Cl. H01F 7/02; H01Q 1/00

(52) U.S. Cl. 343/787; 335/302

(57) ABSTRACT

A superior high-frequency magnetic material having a smaller ratio (μ″/μ′) of the real part μ′ of permeability and the imaginary part μ″ of permeability in a high-frequency region and an antenna device using thereof are provided. The high-frequency magnetic material includes a substrate and a composite magnetic film formed on the substrate that consists of a magnetic phase forming a plurality of columnar bodies whose longitudinal direction is directed in a direction perpendicular to a surface of the substrate and an insulator phase filling gaps of the columnar bodies, and the magnetic phase is amorphous and has in-plane uniaxial anisotropy of Hk2/Hk1≧3 and Hk2≧3.98×10³ A/m when a minimal anisotropic magnetic field in a plane in parallel with the surface of the substrate is Hk1 and a maximal anisotropic magnetic field is Hk2.

### CROSS-REFERENCE TO RELATED APPLICATION

This application is based upon and claims the benefit of priority from Japanese Patent Application No. 2007-226401, filed on Aug. 31, 2007, the entire contents of which are incorporated herein by reference.

### FIELD OF THE INVENTION

The present invention relates to a high-frequency magnetic material and an antenna device using thereof.

### BACKGROUND OF THE INVENTION

High frequencies such as a GHz band are used as a frequency band of radio waves used by current portable devices. However, for example, if a metal is present near an antenna of a portable device when the antenna radiates electromagnetic waves, radiation of electromagnetic waves is disturbed due to an induced current generated in the metal. Thus, by arranging a high-frequency magnetic material (a material that exhibits high permeability in a high-frequency region) near the antenna to suppress generation of an unnecessary induced current, stability in radio frequency communication in a high-frequency region is believed to be achievable.

Metals or alloys having Fe, Co, Ni or the like as main components, or oxides thereof are used as ordinary high permeability members. High permeability members of metal or alloy are not appropriate as high-frequency magnetic materials because transmission losses caused by an eddy current of radio waves become more pronounced as the frequency of radio waves increases.

Magnetic materials of oxide exemplified by ferrite, on the other hand, suppress transmission losses caused by an eddy current because of high resistivity, but the resonance frequencies are several hundred MHz and transmission losses caused by resonance in a high-frequency region higher than these frequencies become more pronounced and therefore, magnetic materials of oxide are not appropriate as high-frequency magnetic materials either.

Thus, development of a high-frequency magnetic material superior in magnetic properties in a high-frequency region up to the GHz band is demanded. A superior high-frequency magnetic material is a material that has high resistivity, a large real part μ′ of permeability, and a small imaginary part μ″ of permeability, that is, small “μ″/μ′” in a high-frequency region.

As an attempt to produce such a high-frequency magnetic material, a high permeability nano-granular material having a granular structure using a thin film technology such as a sputtering method has been made. Here, the granular structure is a structure in which magnetic metal fine particles are dispersed in an insulating matrix and it has been confirmed that such a structure exhibits superior properties also in a high-frequency region (for example, S. Ohmura et al., “High-frequency magnetic properties in metal-nonmetal granular films”, Journal of Applied Physics 79(8) pp. 5130-5135 (1996)). However, with the granular structure, it is difficult to make permeability still higher by improving volume percentage of magnetic metal fine particles in a high-frequency magnetic material.

Also, a high permeability material in a high frequency region having a columnar structure has been produced whose volume percentage of magnetic metals is further improved from that of the granular structure. This is a structure in which magnetic metals in a columnar shape are dispersed in an insulating matrix and it has been confirmed that this structure exhibits higher permeability than the granular structure (for example, N. Hayashi et al., “Soft Magnetic Properties and Microstructure of Ni₈₁Fe₁₉/(Fe₇₀Co₃₀)₉₉(Al₂O₃)₁) Films Deposited by Ion Beam Sputtering”, Transaction of the Materials Research Society of Japan 29[4] pp. 1611-1614 (2004)).

However, materials having the columnar structure have large magnetic anisotropic dispersion caused by a disturbance of crystalline orientation or the like and thus, there is a problem that a loss component μ″ in a high-frequency region is large and μ″/μ′ is also large.

### SUMMARY OF THE INVENTION

A high-frequency magnetic material according to an embodiment of the present invention includes a substrate and a composite magnetic film formed on the substrate. The composite magnetic film consists of a magnetic phase forming a plurality of columnar bodies whose longitudinal direction is directed in a direction perpendicular to a surface of the substrate and an insulator phase filling gaps of the columnar bodies. The magnetic phase is amorphous. The high-frequency magnetic material has in-plane uniaxial anisotropy of Hk2/Hk1≧3 and Hk2≧3.98×10³ A/m when a minimal anisotropic magnetic field in a plane in parallel with the surface of the substrate is Hk1 and a maximal anisotropic magnetic field is Hk2.

An antenna device according to an embodiment of the present invention includes a feed terminal, an antenna element whose one end is connected to the feed terminal, and a high-frequency magnetic material for suppressing transmission losses of electromagnetic waves radiated from the antenna element. The high-frequency magnetic material includes a substrate and a composite magnetic film formed on the substrate. The composite magnetic film consists of a magnetic phase forming a plurality of columnar bodies whose longitudinal direction is directed in a direction perpendicular to a surface of the substrate and an insulator phase filling gaps of the columnar bodies. The magnetic phase is amorphous. The high-frequency magnetic material has in-plane uniaxial anisotropy of Hk2/Hk1≧3 and Hk2≧3.98×10³ A/m when the minimal anisotropic magnetic field in a plane in parallel with the surface of the substrate is Hk1 and the maximal anisotropic magnetic field is Hk2.

### BRIEF DESCRIPTION OF THE DRAWINGS

FIG. 1 is a perspective view and a top view of a high-frequency magnetic material in a first embodiment.

FIG. 2 is a graph showing an applied magnetic field dependence of magnetization.

FIG. 3 is a sectional view of a high-frequency magnetic material in a second embodiment.

FIG. 4 is a perspective view of an antenna device in a third embodiment.

FIG. 5 is a sectional view of the antenna device in the third embodiment.

FIG. 6 is a graph showing an X ray diffraction pattern on a surface of a composite magnetic film in the first embodiment.

FIG. 7 is a TEM observation image on the surface of the composite magnetic film in the first embodiment.

FIG. 8 is a TEM observation image on the cross section of the composite magnetic film in the first embodiment.

FIG. 9 is a graph showing VSM measurement results in the first embodiment.

FIG. 10 is a graph showing high-frequency property measurement results in the first embodiment.

### DETAILED DESCRIPTION OF THE EMBODIMENTS

The inventors found that by using an amorphous magnetic phase in a magnetic material, magnetic anisotropic dispersion can be suppressed and also the loss component of permeability can be reduced more than a composite magnetic film having a crystalline columnar structure while maintaining high permeability in a high-frequency region. The present invention is completed based on the above findings made by the inventors. Amorphous herein refers to a state in which the half width of the strongest peak of Fe in X ray diffraction is 3.0 or more.

### First Embodiment

A high-frequency magnetic material in the first embodiment of the present invention includes a substrate and a composite magnetic film formed on the substrate. The composite magnetic film consists of a magnetic phase forming a plurality of columnar bodies whose longitudinal direction is directed in a direction perpendicular to a surface of the substrate and an insulator phase filling gaps of the columnar bodies. The magnetic phase is amorphous. And the high-frequency magnetic material has in-plane uniaxial anisotropy of Hk2/Hk1≧3 and Hk2≧3.98×10³ A/m (=50 Oe) when the minimal anisotropic magnetic field in a plane in parallel with the surface of the substrate is Hk1 and the maximal anisotropic magnetic field is Hk2. With the present embodiment, a superior high-frequency magnetic material with a small ratio (μ″/μ′) of the real part μ′ of permeability and the imaginary part μ″ of permeability in a high-frequency region can be provided.

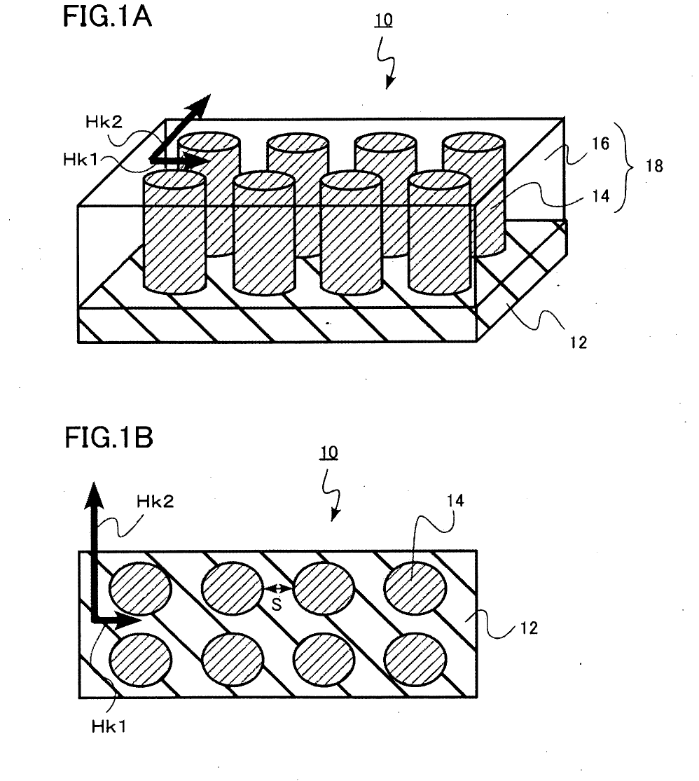

FIG. 1 is a diagram showing the structure of the high-frequency magnetic material in the present embodiment. FIG. 1A is a perspective view and FIG. 1B is a top view. A high-frequency magnetic material 10 illustrated in FIG. 1 has a magnetic phase 14 forming a plurality of columnar bodies whose longitudinal direction is directed in the direction perpendicular to the surface of a substrate 12. The magnetic phase 14 is amorphous. A material containing, in addition to Fe, at least one of B, Co, P, and C is applicable as the magnetic phase 14. By using the magnetic phase 14 in an amorphous state, as described above, magnetic anisotropic dispersion can be suppressed and also the loss component of permeability can be reduced more than a composite magnetic film having a crystalline columnar structure while maintaining high permeability in a high-frequency region.

As shown in FIG. 1A and FIG. 1B, the high-frequency magnetic material 10 has in-plane uniaxial anisotropy of Hk2/Hk1≧3 and Hk2≧3.98×10³ A/m (=50 Oe) when the minimal anisotropic magnetic field in a plane in parallel with the surface of the substrate is Hk1 and the maximal anisotropic magnetic field is Hk2. A high-frequency magnetic material according to the present embodiment can reduce the loss component of permeability in a high-frequency region by including in-plane uniaxial anisotropy in the above range.

The loss component of permeability in a high-frequency region being enabled to reduce in a high-frequency region by having in-plane uniaxial anisotropy can be considered as follows: The maximal anisotropic magnetic field and a resonance frequency of permeability are in a linear relation and the resonance frequency of 1 GHz or more can be achieved by setting Hk2≧3.98×10³ A/m. Then, in order to attain Hk2≧3.98×10³ A/m, it is effective to provide in-plane uniaxial anisotropy satisfying Hk2/Hk1≧3. By having in-plane uniaxial anisotropy, as described above, the maximal anisotropic magnetic field can be made larger than when magnetic properties are isotropic and, as a result, μ″/μ′ in a high-frequency region can be made smaller.

By using an amorphous magnetic phase and including in-plane uniaxial anisotropy satisfying Hk2/Hk1≧3 and Hk2≧3.98×10³ A/m when the minimal anisotropic magnetic field in a plane in parallel with the surface of the substrate is Hk1 and the maximal anisotropic magnetic field is Hk2, as described above, the loss component of permeability in a high-frequency region can greatly be reduced.

FIG. 1 exemplifies an elliptical columnar body whose section perpendicular to the longitudinal direction of the columnar body of the magnetic phase 14 has an elliptical shape, but in addition to the elliptical columnar body, other shapes such as a cylindrical body, a square columnar body, a hexagonal columnar body, and an octagonal columnar body are also allowed. An insulator phase 16 is formed between these columnar bodies. A portion combining the magnetic phase 14 and the insulator phase 16 is called a composite magnetic film 18.

It is preferable that 5 nm≦D≦20 nm and D/S≧4 be satisfied when an average value of a diameter at a bottom of columnar bodies in the magnetic phase 14 is D and that of an interval between the columnar bodies is S (FIG. 1B). Here, arbitrary two locations on the surface in parallel with the substrate of the high-frequency magnetic material are observed using a transmission electron microscope (of a magnification of 400,000 times). Then, the maximal and minimal diameters at the bottom of all columnar bodies included in a range corresponding to 100 nm in four directions from the center of each observation photograph are measured and the average value of all these values is set as D. If apparently any columnar body formed by a plurality of columnar bodies being coalesced is present, such a columnar body shall be excluded from measurement. A total of 20 columnar bodies, 10 from each photograph, is randomly selected from 100 nm in four directions from the center of each observation photograph at two locations described above and intervals between each columnar body and adjacent columnar bodies are measured to set the average value of all measured values as S.

If D is smaller than 5 nm, there is a possibility that forming a columnar body is difficult and the volume percentage of the magnetic phase 14 in a high-frequency magnetic material decreases, leading to lower permeability. If D is larger than 20 nm, there is a possibility that coercive force becomes larger to increase losses of permeability. If D/S is smaller than 4, there is a possibility that the volume percentage of the magnetic phase 14 decreases, leading to lower permeability.

The ratio of the height of a columnar body to the diameter (aspect ratio) is preferably 5 or more. Here, the diameter is the average value D of diameters at the bottom of columnar bodies. Also, arbitrary two locations perpendicular to the substrate of the high-frequency magnetic material are observed using a transmission electron microscope (of a magnification of 400,000 times). Then, a total of 20 columnar bodies, 10 from each photograph, is selected in descending order of height (length) in each observation photograph to define the average value of heights thereof as the height of the columnar bodies.

If the aspect ratio is smaller than 5, the insulator phase 16 will be present between bottoms of columns, leading to lower permeability due to lower volume percentage of the magnetic phase 14. FIG. 1A illustrates only one columnar body in a direction perpendicular to the surface of the substrate 12. However, a plurality of columnar bodies may actually be arranged in the direction perpendicular to the surface of the substrate 12, sandwiching the insulator phase 16 in the longitudinal direction of the columnar bodies.

In the composite magnetic film 18, a ratio P of an area occupied by the magnetic phase 14 in a plane in parallel with the surface of the substrate 12 is preferably 75%≦P≦95%. If P is less than 75%, there is a possibility that the volume percentage of the magnetic phase 14 decreases, leading to lower permeability. If P is more than 95%, there is a possibility that columnar bodies condense to make D larger than 20 nm, increasing losses of permeability, as described above.

If the magnetic phase 14 is M, the insulator phase 16 is I, and the composite magnetic film 18 is MₓI₍₁₋ₓ₎, 0.80≦x≦0.95 is preferably satisfied, that is, the ratio of the magnetic phase occupied in the composite magnetic film is preferably 80 mol % or more and 95 mol % or less. If the magnetic phase 14 is less than 80 mol %, there is a possibility that the volume percentage of the magnetic phase 14 decreases to build a granular structure, leading to lower permeability. If the magnetic phase 14 is more than 95 mol %, there is a possibility that columnar bodies condense to make D larger than 20 nm, increasing losses of permeability, as described above.

A high-frequency magnetic material according to the present embodiment can be manufactured by forming a composite magnetic film by the sputtering method, electron-beam evaporation method or the like. By rotating the substrate and controlling film formation conditions, magnetic in-plane uniaxial anisotropy in a plane in parallel with the surface of the substrate can effectively be provided to the composite magnetic film formed on the substrate.

For example, plastics such as polyimide, SiO₂, Al₂O₃, MgO, Si, and inorganic material such as glass can be used as a substrate according to the present embodiment. However, the material of the substrate is not limited to these materials.

As shown in FIG. 1, the magnetic phase in the present embodiment has a structure of columnar bodies whose longitudinal direction is directed in the direction perpendicular to the surface of the substrate. However, columnar bodies are partially permitted to tilt at an angle of ±30° , preferably ±10°.

It is preferable that the magnetic phase 14 including columnar bodies contain at least Fe and B (boron). By adding B to Fe, columnar bodies of Fe can be made amorphous more easily.

It is preferable that a ratio y of B contained in the magnetic phase 14 is 10 at %≦y≦25 at %. If B is less than 10 at %, columnar bodies of Fe are difficult to be made amorphous, and if B is more than 25 at %, the ratio of Fe decreases, leading to lower permeability.

Whether a columnar body of the magnetic phase 14 is amorphous can be determined by an X ray diffraction pattern or an electron diffraction pattern. In an X ray diffraction pattern, there is no sharp and strong peak like that of a crystal and instead, a broad and weak peak appears. In an electron diffraction pattern, a halo ring appears, instead of apparent spots. As already described above, amorphous herein refers to a state in which the half width of the strongest peak of Fe in X ray diffraction is 3.0 or more.

If a crystalline orientation is disturbed (that is, polycrystal) in crystalline columnar bodies, magnetic anisotropic dispersion becomes large, increasing the loss component (imaginary part μ″) of permeability. However, there is no disturbance of crystalline orientation in amorphous columnar bodies and therefore, magnetic anisotropic dispersion is extremely small and μ″ can also be made smaller.

If a metal is made amorphous, electric resistivity can be made larger than that of crystalline metal. That is, by using amorphous columnar bodies for a magnetic phase, a superior high-frequency magnetic material exhibiting high permeability, low losses, and high resistivity in a high-frequency region can be produced.

It is preferable to mix Fe and Co to increase permeability and the ratio of Co in FeCo is preferably 20 at % or more and 40 at % or less.

As shown in FIG. 1, the insulator phase in the present embodiment fills gaps of columnar bodies of the magnetic phase 14. In terms of suppressing transmission losses caused by an eddy current, the material of the insulator phase 16 preferably has electric resistivity of 1×10² Ωcm or more at room temperature.

The material of the insulator phase 16 includes oxide, nitride, carbide, and fluoride of metal selected, for example, from a group consisting of Mg, Al, Si, Ca, Cr, Ti, Zr, Ba, Sr, Zn, Mn, Hf, and rare earth elements (including Y). In terms of easiness and costs of film formation, particularly oxide, among others, silicon oxide and aluminum oxide are preferable.

The insulator phase 16 permits inclusion of 30 mol % or less of magnetic metal elements. If the amount of magnetic metal elements exceeds 30 mol %, electric resistivity of the insulator phase 16 may decrease, leading to reduced magnetic properties of the whole composite magnetic film.

Next, magnetic in-plane uniaxial anisotropy of a composite magnetic film according to the present invention will be described. The composite magnetic film 18 shown in FIG. 1 has magnetic in-plane uniaxial anisotropy satisfying Hk2/Hk1≧3 and Hk2≧3.98×10³ A/m (=50 Oe) when the minimal anisotropic magnetic field in a plane in parallel with the surface of the substrate is Hk1 and the maximal anisotropic magnetic field is Hk2.

By providing uniaxial anisotropy, as described above, the maximal anisotropic magnetic field can be made larger than when magnetic properties are isotropic, making it easier to obtain an anisotropic magnetic field of 3.98×10³ A/m or more. The maximal anisotropic magnetic field and the resonance frequency of permeability are in a linear relationship and setting Hk2≧3.98×10³ A/m makes it easier to attain the resonance frequency of 1 GHz or more. In order to attain Hk2≧3.98×10³ A/m, it is effective to provide uniaxial anisotropy satisfying Hk2/Hk1≧3. By providing uniaxial anisotropy and making the maximal anisotropic magnetic field larger, as described above, μ″/μ′ in a high-frequency region can be made smaller.

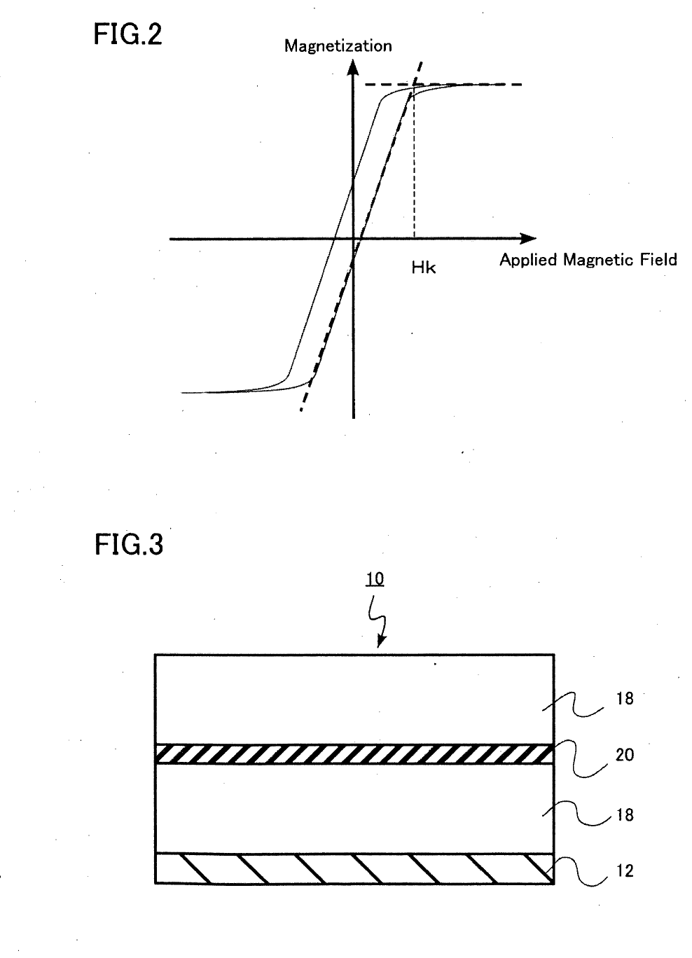

As shown in FIG. 2, Hk (Hk1 and Hk2) is defined herein as a magnetic field at the intersection of a tangent in a magnetic field in which the amount of magnetization changes to an applied magnetic field is the largest (≧0) and that in a magnetic field in which the magnetization amount of changes is the smallest, in the first quadrant (magnetization>0, applied magnetic field>0) of a magnetization curve.

Such magnetic anisotropy can be realized, for example, by making the diameter in the direction corresponding to the anisotropic magnetic field Hk1 of a columnar body on the surface of the composite magnetic film 18 longer and that in the direction corresponding to the anisotropic magnetic field Hk2 shorter.

Magnetic anisotropy can also be provided by changing the amount of magnetic elements in the insulator phase 16. Magnetic anisotropy can be realized, for example, by making columnar bodies in the direction corresponding to the anisotropic magnetic field Hk1 on the surface of the composite magnetic film 18 have more magnetic elements in the insulator phase 16 than those in the direction corresponding to the anisotropic magnetic field Hk2.

It is also possible to provide magnetic anisotropy by making the interatomic distance of Fe in the direction corresponding to the anisotropic magnetic field Hk1 on the surface of the composite magnetic film 18 longer than that of Fe in the direction corresponding to the anisotropic magnetic field Hk2.

The high-frequency magnetic material 10 according to the present embodiment permits formation of a thin film layer containing a different material from that of the composite magnetic film 18 between the substrate 12 and the composite magnetic film 18. When the composite magnetic film 18 is formed on such a thin film layer, the high-frequency magnetic material 10 whose magnetic properties have further improved can be obtained, for example, by being able to control the diameter of columnar bodies in the magnetic phase 14 of the composite magnetic film 18 and reducing disturbances of a magnetic structure at an interface between the substrate 12 and the composite magnetic film 18.

The thin film layer is preferably selected from Ni, Fe, Cu, Ta, Cr, Co, Zr, Nb, Ru, Ti, Hf, W, Au, or an alloy thereof, or oxide such as SiO₂ and Al₂O₃.

Then, the thin film layer preferably has thickness of 50 nm or less. If thickness of the thin film layer exceeds 50 nm, there is a possibility that the volume percentage of the magnetic phase 14 in the high-frequency magnetic material decreases, leading to lower permeability.

The high-frequency magnetic material preferably has high resistivity in a high-frequency region to suppress transmission losses caused by an eddy current. It is effective to cut a slit in the material to cause the high-frequency magnetic material to have higher resistivity. Generation of an eddy current can be suppressed by cutting a slit at intervals of 100 to 1000 μm and making the high-frequency magnetic material finer.

### Second Embodiment

A high-frequency magnetic material according to the second embodiment of the present invention is the same as that according to the first embodiment except that a plurality of insulator layers in parallel with a substrate lies in a composite magnetic film. Therefore, a description of portions that overlap with those of the first embodiment is omitted below.

FIG. 3 is a sectional view of a high-frequency magnetic material in the present embodiment. As shown in FIG. 3, the high-frequency magnetic material in the present embodiment has a structure in which at least two layers of the composite magnetic film 18 are laminated on the substrate 12 and an insulator layer 20 is formed between these composite magnetic films 18.

By causing the insulator layer 20 to lie between two or more layers of the composite magnetic film 18, that is, by making the film thicker by separating the composite magnetic film 18 in the thickness direction through the insulator layer 20 to reduce an influence of a demagnetizing field generated when the composite magnetic film 18 is made thicker without causing the insulator layer 20 to lie in the composite magnetic film 18, as described above, magnetic properties of the whole high-frequency magnetic material 10 can be improved. Also, disturbances of the structure in the thickness direction that could occur when the composite magnetic film 18 is made thicker can be avoided.

The insulator layer 20 is preferably made of at least one selected, for example, from a group of oxide, nitride, carbide, and fluoride of metal selected from a group of Mg, Al, Si, Ca, Cr, Ti, Zr, Ba, Sr, Zn, Mn, Hf, and rare earth elements (including Y). Particularly, it is preferable to select a material for the insulator layer 20 that is of the same kind as that of the insulator phase 16 constituting the composite magnetic film 18.

The insulator layer 20 has preferably thickness of 5 nm or more and 100 nm or less, more preferably 50 nm or less. If the insulator layer 20 has thickness exceeding 100 nm, the volume percentage of the magnetic phase in the high-frequency magnetic material 10 decreases, leading to lower permeability. If the insulator layer 20 has thickness below 5 nm, there is a possibility that an influence of a demagnetizing field becomes more pronounced because magnetic coupling between the composite magnetic films 18 is not cut off.

### Third Embodiment

An antenna device according to the third embodiment of the present invention includes a feed terminal, an antenna element whose one end is connected to the feed terminal, and a high-frequency magnetic material for suppressing transmission losses of electromagnetic waves radiated from the antenna element. Then, the high-frequency magnetic material is the high-frequency magnetic material described in the first embodiment or the second embodiment. Therefore, a description of the high-frequency magnetic material is omitted below due to an overlap with that of the high-frequency magnetic material in the first embodiment or second embodiment.

According to the present embodiment, an antenna device using a superior high-frequency magnetic material with a small ratio (μ″/μ′) of the real part μ′ of permeability and the imaginary part μ″ of permeability in a high-frequency region can be provided.

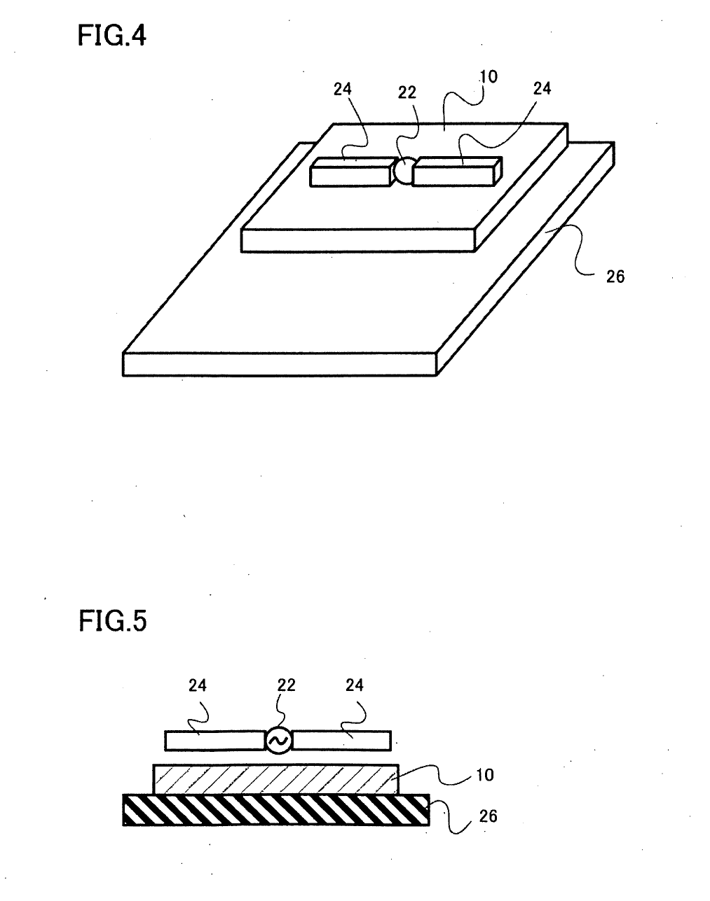

FIG. 4 is a perspective view of an antenna device according to the present embodiment and FIG. 5 is a sectional view thereof. The high-frequency magnetic material 10 is provided between antenna elements 24 whose one end is connected to a feed terminal 22 and a wired substrate 26. The wired substrate 26 is, for example, a wired substrate of a portable device and is enclosed, for example, by a metallic chassis.

When an antenna of a portable device radiates electromagnetic waves, for example, radiation of electromagnetic waves is disturbed due to an induced current generated in a metal when the antenna and the metal such as a chassis come closer than a certain distance. However, if a high-frequency magnetic material is arranged near the antenna, no induced current is caused even if the antenna and the metal such as a chassis are brought closer so that radio frequency communication can be stabilized and the portable device can be made smaller.

By inserting the high-frequency magnetic material 10 between the two antenna elements 24 sandwiching the feed terminal 22 and the wired substrate 26, like the present embodiment, an induced current generated in the wired substrate 26 is suppressed when electromagnetic waves are radiated by the antenna elements 24 so that radiation efficiency of the antenna device can be improved.

Embodiments of the present invention have been described above with reference to concrete examples. The above embodiments are shown strictly as examples and do not limit the present invention. Though descriptions of parts that were not directly necessary to describe the present invention such as a high-frequency magnetic material and an antenna device using thereof were omitted when describing the embodiments, necessary components related to the high-frequency magnetic material or the antenna device using thereof can appropriately be selected and used.

In addition, all high-frequency magnetic materials whose design can appropriately be modified by a person skilled in the art and antenna devices using thereof are included in the scope of the present invention. The scope of the present invention is defined by appended claims and equivalents thereof.

### EXAMPLES

Examples of the present invention will be described below in detail.

### Example 1

An opposed type magnetron sputter film deposition system was used. Fe_{54.6}Co_{23.4}B₂₂—SiO₂ (among them, FeCoB to be the magnetic phase occupies 93 mol %, that is, x=0.93) was used as the target (that is, the ratio of B in the magnetic phase is y=22 at %). A rotating holder was arranged inside a chamber and an SiO₂ substrate was fixed onto the holder. While rotating the substrate at 10 rpm, sputtered particles from the target were caused to deposit onto the substrate surface under pressure of 0.67 Pa (5×10⁻³ Torr) in an Ar atmosphere inside the chamber to form a composite magnetic film of thickness 0.31 μm.

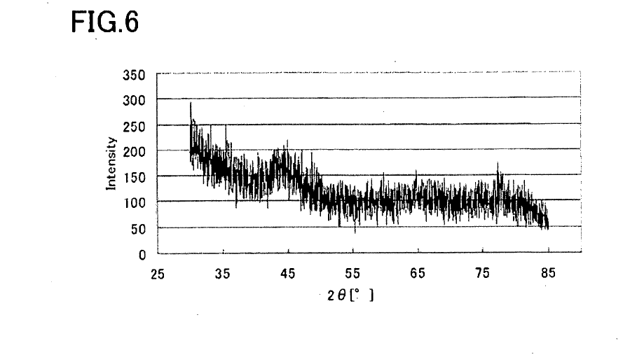

CuKα ray/X ray diffraction measurement (XRD) was made on the surface of the composite magnetic film. Measurement results are shown in FIG. 6. The half width F of a (110) peak of Fe near 2θ=45° is 6.04, showing that the film is in an amorphous state.

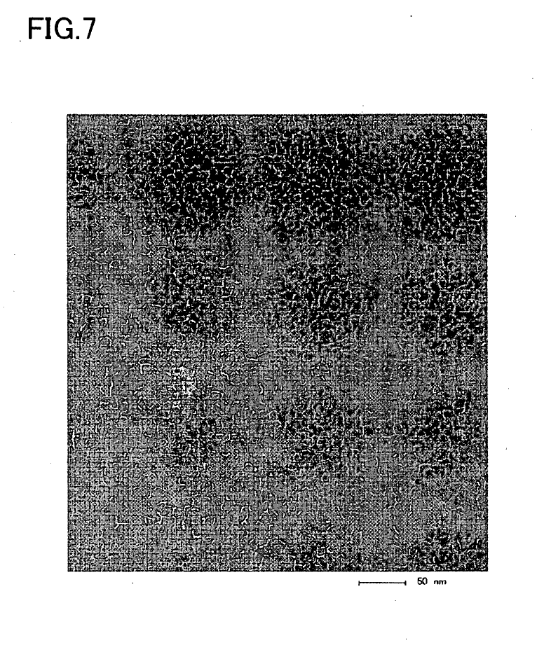

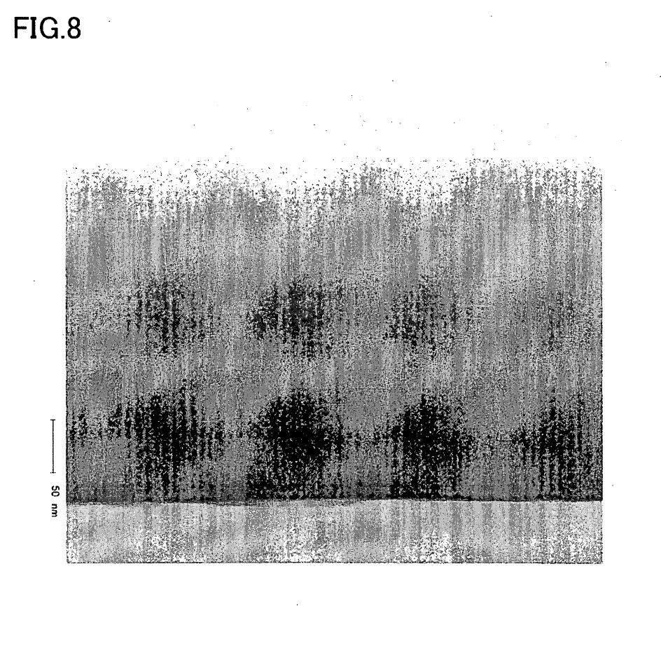

The composite magnetic film was observed under a transmission electron microscope (TEM). FIG. 7 shows an image in a plane in parallel with the substrate surface and FIG. 8 shows an image in a plane perpendicular to the substrate surface. The magnification is 400,000 times in both cases. It is clear from FIG. 7 and FIG. 8 that an insulator phase is formed between columnar bodies.

In the two photographs observed like FIG. 7 using transmission electron microscope, the maximal and minimal diameters at the bottom of all columnar bodies included in a range corresponding to 100 nm in four directions from the center of each observation photograph were measured and an average value of all these values was calculated to obtain D=10 nm. Also, a total of 20 columnar bodies, 10 from each photograph, was randomly selected from 100 nm in four directions from the center of each observation photograph and intervals between each columnar body and adjacent columnar bodies were measured and an average value of all these values was calculated to obtain S=1.2 nm. The ratio P of an area occupied by the magnetic phase was 90% from FIG. 7.

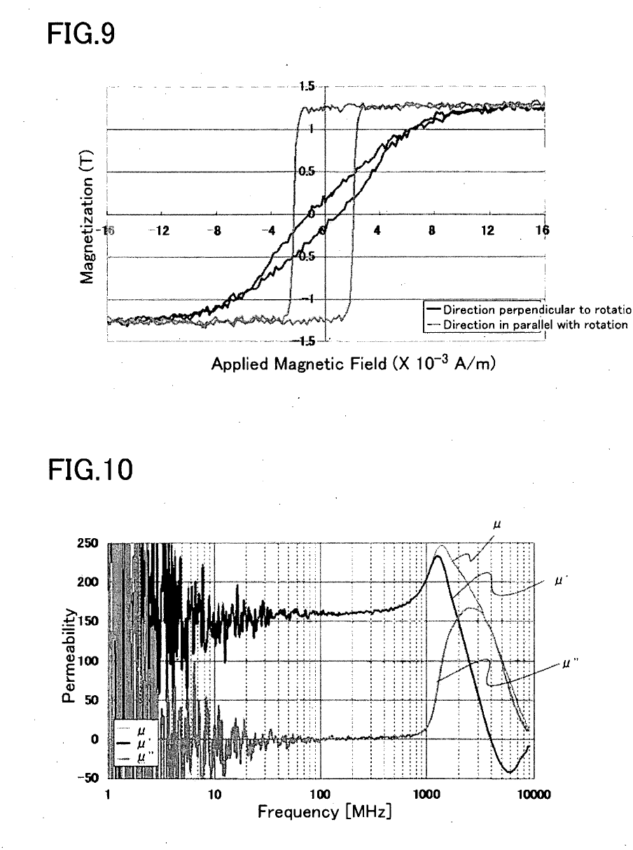

A vibrating sample magnetometer (VSM) was used to measure magnetic properties (magnitude of magnetization in an applied magnetic field) of the composite magnetic film in the direction in parallel with the substrate rotation for film formation and in the direction perpendicular to the substrate rotation. FIG. 9 shows a result thereof. The minimal anisotropic magnetic field Hk1 in the direction in parallel with the substrate rotation was 2.20×10³ A/m and the maximal anisotropic magnetic field Hk2 in the direction perpendicular to the substrate rotation was 7.94×10³ A/m.

A super-high frequency permeability measuring system PMM-9G1 manufactured by Ryowa Electronics was used to make measurement with magnetizing the composite magnetic film in the range of 1 MHz to 9 GHz. FIG. 10 shows a result thereof. The real part μ′ of permeability at 1 GHz was 202.2, the imaginary part μ″ of permeability showing a loss component of permeability at 1 GHz was 13.7, and μ″/μ′ showing magnetic properties at 1 GHz was 0.068. The above measurement results are listed in Table 1.

### Example 2

Film formation and measurement were performed in the same manner as in Example 1 except that x=0.80 was set. Results thereof are listed in Table 1.

### Example 3

Film formation and measurement were performed in the same manner as in Example 1 except that x=0.95 was set. Results thereof are listed in Table 1.

### Example 4

Film formation and measurement were performed in the same manner as in Example 1 except that x=0.97 was set. Results thereof are listed in Table 1.

### Comparative Example 1

Film formation and measurement were performed in the same manner as in Example 1 except that x=0.75 was set. The magnetic phase had a granular structure, instead of the columnar structure. Results thereof are listed in Table 1.

### Comparative Example 2

Film formation and measurement were performed in the same manner as in Example 1 except that the substrate was rotated at 5 rpm. Results thereof are listed in Table 1.

### Comparative Example 3

Film formation and measurement were performed in the same manner as in Example 1 except that the pressure was changed to 0.27 Pa (2×10⁻³ torr) in an Ar atmosphere inside the chamber. Results thereof are listed in Table 1.

### Example 5

Film formation and measurement were performed in the same manner as in Example 1 except that y=10 at % was set. Results thereof are listed in Table 1.

### Example 6

Film formation and measurement were performed in the same manner as in Example 1 except that y=25 at % was set. Results thereof are listed in Table 1.

### Example 7

Film formation and measurement were performed in the same manner as in Example 1 except that y=30 at % was set. Results thereof are listed in Table 1.

### Comparative Example 4

Film formation and measurement were performed in the same manner as in Example 1 except that y=8 at % was set. The half width of a peak of Fe in XRD was 0.54 and the magnetic phase had a crystalline columnar structure. Results thereof are listed in Table 1.

TABLE 1

| | | | | | D | S | | | | | | | | |
|---|---|---|---|---|---|---|---|---|---|---|---|---|---|---|
| | | | | y | average | average | | P | Hk1 | Hk2 | Hk2/ | | | |
| | Structure | Crystallinity | x | [at %] | [nm] | [nm] | D/S | [%] | [×10⁶ A/m] | [×10⁶ A/m] | Hk1 | μ′ | μ″ | μ″/μ′ |
| Example 1 | Columnar | Amorphous | 0.93 | 22 | 10 | 1.2 | 8.3 | 90 | 2.20 | 7.94 | 3.6 | 202.2 | 13.7 | 0.068 |
| Example 2 | Columnar | Amorphous | 0.80 | 22 | 9 | 1.8 | 5.0 | 83 | 1.69 | 7.92 | 4.7 | 197.7 | 14.0 | 0.071 |
| Example 3 | Columnar | Amorphous | 0.95 | 22 | 10 | 0.9 | 11.1 | 90 | 1.86 | 7.89 | 4.2 | 192.9 | 13.8 | 0.072 |
| Example 4 | Columnar | Amorphous | 0.97 | 22 | 40 | 3.0 | 20.0 | 97 | 1.44 | 4.33 | 3.0 | 195.5 | 37.1 | 0.19 |
| Comparative | Granular | Amorphous | 0.75 | 22 | 30 | 9.0 | 3.3 | 70 | 1.20 | 5.35 | 4.5 | 100.2 | 59.8 | 0.60 |
| Example 1 | | | | | | | | | | | | | | |
| Comparative | Columnar | Amorphous | 0.93 | 22 | 10 | 1.2 | 8.3 | 90 | 1.45 | 3.85 | 2.7 | 200.4 | 130.4 | 0.65 |
| Example 2 | | | | | | | | | | | | | | |
| Comparative | Columnar | Amorphous | 0.93 | 22 | 10 | 1.2 | 8.3 | 90 | 3.58 | 3.58 | 1.0 | 147.1 | 144.8 | 0.98 |
| Example 3 | | | | | | | | | | | | | | |
| Example 5 | Columnar | Amorphous | 0.93 | 10 | 10 | 1.2 | 8.3 | 90 | 2.84 | 8.56 | 3.0 | 200.2 | 7.07 | 0.035 |
| Example 6 | Columnar | Amorphous | 0.93 | 25 | 10 | 1.3 | 7.7 | 90 | 1.99 | 7.78 | 3.9 | 175.9 | 15.5 | 0.088 |
| Example 7 | Columnar | Amorphous | 0.93 | 30 | 10 | 1.5 | 6.7 | 87 | 0.96 | 7.60 | 7.9 | 155.4 | 34.2 | 0.22 |
| Comparative | Columnar | Crystal | 0.93 | 8 | 10 | 2.0 | 5.0 | 83 | 1.59 | 7.81 | 4.9 | 114.0 | 88.6 | 0.78 |
| Example 4 | | | | | | | | | | | | | | |

The composite magnetic film in Example 1 has an amorphous columnar structure and, as is evident from Table 1, the imaginary part μ″ of permeability (loss component of permeability) at 1 GHz and the ratio (μ″/μ′) of the real part of permeability and the imaginary part of permeability at 1 GHz are smaller than those of Comparative Example 1 having the granular structure, Comparative Examples 2 and 3 satisfying Hk2/Hk1<3 and Hk2<3.98×10³ A/m, and Comparative Example 4 having the crystalline columnar structure, showing that the composite magnetic film in Example 1 has superior magnetic properties in a high-frequency region.

Examples 1, 2, and 3 in which the ratio of the magnetic phase is 80 mol % or more and 95 mol % or less, 5 nm≦D≦20 nm, D/S≧4, and 75%≦P≦95% have lower μ″/μ′ than that in Example 4 and Comparative Example 1 in which these values deviate from at least one of these ranges, showing that the composite magnetic film in these examples has superior magnetic properties in a high-frequency region.

Examples 5 and 6 in which the amount of addition of B into the magnetic phase is in the range of 10 at %≦y≦25 at % have lower μ″/μ′ than that in example 5 and Comparative Example 4 in which the amount of addition of B deviates from the range, showing that the composite magnetic film in these examples has superior magnetic properties in a high-frequency region.

Accordingly, an effect of the present invention has been confirmed by these examples.

Additional advantages and modification will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A high-frequency magnetic material, comprising:
a substrate; and
a composite magnetic film formed on the substrate, the film consists of a magnetic phase forming a plurality of columnar bodies whose longitudinal direction is directed in a direction perpendicular to a surface of the substrate and an insulator phase filling gaps of the columnar bodies, wherein
the magnetic phase is amorphous and
the high-frequency magnetic material has in-plane uniaxial anisotropy of Hk2/Hk1≧3 and Hk2≧3.98×10³ A/m when a minimal anisotropic magnetic field in a plane in parallel with the surface of the substrate is Hk1 and a maximal anisotropic magnetic field is Hk2.

2. The high-frequency magnetic material according to claim 1, wherein when an average value of a diameter at a bottom of the columnar bodies is D and that of an interval between the columnar bodies is S,
5 nm≦D≦20 nm and D/S≧4 are satisfied, and
a ratio P of an area occupied by the magnetic phase in a section of the composite magnetic film in parallel with the surface of the substrate is 75%≦P≦95%.

3. The high-frequency magnetic material according to claim 1, wherein when the magnetic phase is M, the insulator phase is I, and the composite magnetic film is MₓI₍₁₋ₓ₎, 0.80≦x≦0.95 is satisfied.

4. The high-frequency magnetic material according to claim 1, wherein the magnetic phase contains at least Fe and B (boron) and
the insulator phase contains at least an oxide.

5. The high-frequency magnetic material according to claim 1, wherein a ratio y of B contained in the magnetic phase to the whole magnetic phase is 10 at %≦y≦25 at %.

6. The high-frequency magnetic material according to claim 1, wherein the ratio of a height of the columnar bodies to a diameter at a bottom thereof is 5 or more.

7. The high-frequency magnetic material according to claim 1, wherein the magnetic phase contains at least Fe and Co and
the insulator phase contains at least an oxide.

8. The high-frequency magnetic material according to claim 7, wherein a ratio z of Co contained in the magnetic phase to the whole magnetic phase is 20 at %≦z≦40 at %.

9. The high-frequency magnetic material according to claim 1, wherein a plurality of insulator layers in parallel with the substrate lies in the composite magnetic film.

10. The high-frequency magnetic material according to claim 9, wherein thickness of the insulator layer is 5 nm or more and 100 nm or less.

11. An antenna device, comprising:
a feed terminal;
an antenna element whose one end is connected to the feed terminal; and
a high-frequency magnetic material for suppressing transmission losses of electromagnetic waves radiated from the antenna element, wherein
the high-frequency magnetic material comprises a substrate and a composite magnetic film formed on the substrate, the film consists of a magnetic phase forming a plurality of columnar bodies whose longitudinal direction is directed in a direction perpendicular to a surface of the substrate and an insulator phase filling gaps of the columnar bodies and
the magnetic phase is amorphous and
the high-frequency magnetic material has in-plane uniaxial anisotropy of Hk2/Hk1≧3 and Hk2≧3.98×10³ A/m when a minimal anisotropic magnetic field in a plane in parallel with the surface of the substrate is Hk1 and a maximal anisotropic magnetic field is Hk2.

12. The antenna device according to claim 11, wherein when an average value of a diameter at a bottom of the columnar bodies is D and that of an interval between the columnar bodies is S,
5 nm≦D≦20 nm and D/S≧4 are satisfied, and
a ratio P of an area occupied by the magnetic phase in a section of the composite magnetic film in parallel with the surface of the substrate is 75%≦P≦95%.

13. The antenna device according to claim 11, wherein when the magnetic phase is M, the insulator phase is I, and the composite magnetic film is MₓI₍₁₋ₓ₎, 0.80≦x≦0.95 is satisfied.

14. The antenna device according to claim 11, wherein the magnetic phase contains at least Fe and B (boron) and
the insulator phase contains at least an oxide.

15. The antenna device according to claim 14, wherein a ratio y of B contained in the magnetic phase to the whole magnetic phase is 10 at %≦y≦25 at %.

16. The antenna device according to claim 11, wherein the ratio of a height of the columnar bodies to a diameter at a bottom thereof is 5 or more.

17. The antenna device according to claim 11, wherein the magnetic phase contains at least Fe and Co and
the insulator phase contains at least an oxide.

18. The antenna device according to claim 17, wherein a ratio z of Co contained in the magnetic phase to the whole magnetic phase is 20 at %≦z≦40 at %.

19. The antenna device according to claim 11, wherein a plurality of insulator layers in parallel with the substrate lies in the composite magnetic film.

20. The antenna device according to claim 19, wherein thickness of the insulator layer is 5 nm or more and 100 nm or less.
